(19) United States
(12) Patent Application Publication
(10) Pub. No.: US 2012/0175851 A1
(43) Pub. Date: Jul. 12, 2012

(54) Safety System for Equipment Controller

(75) Inventor: Robert Ferrell, Johns Creek, GA (US)

(73) Assignee: Allied Automotive Group, Atlanta, GA (US)

(21) Appl. No.: 13/004,641

(22) Filed: Jan. 11, 2011

(51) Int. Cl. B60G 17/018; B60G 17/015; G05B 9/02; G05G 1/04

(52) U.S. Cl. 280/6.15; 74/526; 700/79

(57) ABSTRACT

A heavy equipment system is provided that includes a tractor for hauling a trailer, wherein the trailer may have its height adjusted by a hydraulic system controlled by a bank of control levers. Also included is a safety system that comprises a blocking member, such as a handle, a sensor and a communication system. The safety system operates to sense and communicate to a driver of the tractor the possibility that the trailer is in the raised position by sensing when the blocking member is in a position to allow access to the control levers. Advantageously, such a system can guard against a driver driving into a low overpass or other hazard with the trailer in an elevated position.

### BACKGROUND OF THE INVENTION

Heavy equipment is often raised and lowered, or otherwise moved, by a controller. For example, tractors for hauling trailers may include a collection levers for operating hydraulic valves. Pushing the levers raises the trailer, or components of the trailer such as ramps on a car hauler, of the truck and pulling the levers lowers the trailer of the truck. Leaving the trailer in an elevated position may result in the trailer hitting a low underpass.

### SUMMARY OF THE INVENTION

A safety system is provided for a machine having a controller configured to move a machine component. The safety system includes a blocking member configured to inhibit operation of the controller and a sensor configured to sense a position of the blocking member. The safety system also includes a communication system configured to communicate information about a position of the machine component based on the sensed position of the blocking member.

For example, a bar may block operation of a bank of valve controls for raising and lowering trailer ramps on a car hauler. The position of the bar allowing access to the controls may be communicated to a cab of the car hauler to ensure the driver does not drive an elevated trailer into an overpass.

The blocking member may also be configured to move into a blocking position inhibiting operation of the controller and an access position enabling operation of the controller. The sensor is configured to sense when the blocking member is in one of the blocking or access positions.

The controller may also be configured to raise and lower the machine component. The blocking position of the blocking member may inhibit use of the controller to lower the machine component. For example, the controller may include a lever (or levers) and pushing the lever forward raises the machine component. Pulling the lever back lowers the machine component. The blocking member includes a handle that has a bar that, in the blocking position, extends into a path of travel of the lever and blocks pulling of the lever. The sensor is configured to sense when the blocking member is in this access position and out of the path of travel of the controller lever. When access to the controller is allowed, the trailer may still be in the raised position.

Also, the blocking member may include a handle that pivots about a pivot point from the blocking position to the access position. The handle may include an elongate bar that, in the blocking position, extends perpendicular to a path of travel of the controller. Also the controller and handle may pivot about parallel axes, with the bar pivoting about an arc at a greater radius than the controller.

The communication system may also include a display configured to show a warning. And, the display may be remote from the controller and not visible while operating a second controller. The second controller may also be configured to move another component of the machine. The warning may be associated with and indicate movement of the component of the machine. For example, the machine may be a trailer and the movement includes raising and lowering of the trailer. The warning includes indicia of the trailer being in the raised position. And, the display may be mounted in the cab of a tractor connected to the trailer where controls for driving the tractor are located.

These and other features and advantages of the present system and methods will become more readily apparent to those skilled in the art upon consideration of the following detailed description and accompanying drawings.

### BRIEF DESCRIPTION OF THE DRAWINGS

FIG. 1 is a schematic of a heavy equipment system;

FIG. 2 is a perspective view of a safety system of the heavy equipment system shown in FIG. 1;

FIG. 3 is a side elevation view of a handle assembly of the safety system shown in FIG. 2;

FIG. 4 is a plan view of a first support plate of the handle assembly of FIG. 3;

FIG. 5 is a plan view of a second support plate of the handle assembly of FIG. 3;

FIG. 6 is a plan view of a first pivot arm of the handle assembly of FIG. 3;

FIG. 7 is a plan view of a second pivot arm of the handle assembly of FIG. 3;

FIGS. 8 and 9 are plan and elevation views of a ratchet support assembly of the handle assembly of FIG. 3;

FIG. 10 is a ratchet pawl of the ratchet support assembly of the handle assembly of FIG. 3; and

FIG. 11 is a perspective view of a handle of the safety system of FIG. 3 in an access position.

### DETAILED DESCRIPTION OF THE INVENTION

The system can be embodied in many different forms and should not be construed as limited to the embodiments set forth herein. As used in the specification, and in the appended claims, the singular forms “a”, “an”, “the”, include plural referents unless the context clearly dictates otherwise. The term “comprising” and variations thereof as used herein is used synonymously with the term “including” and variations thereof and are open, non-limiting terms.

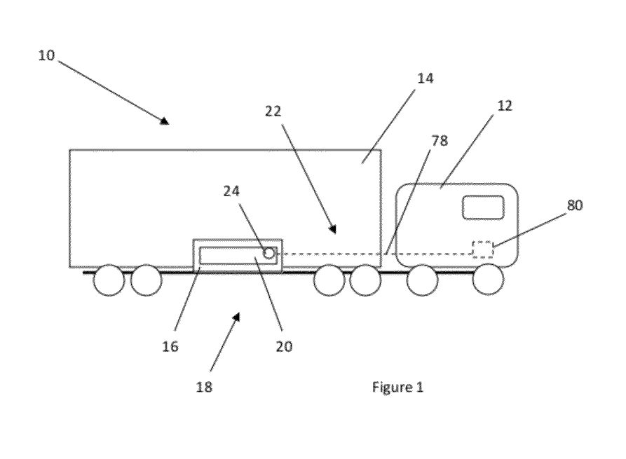

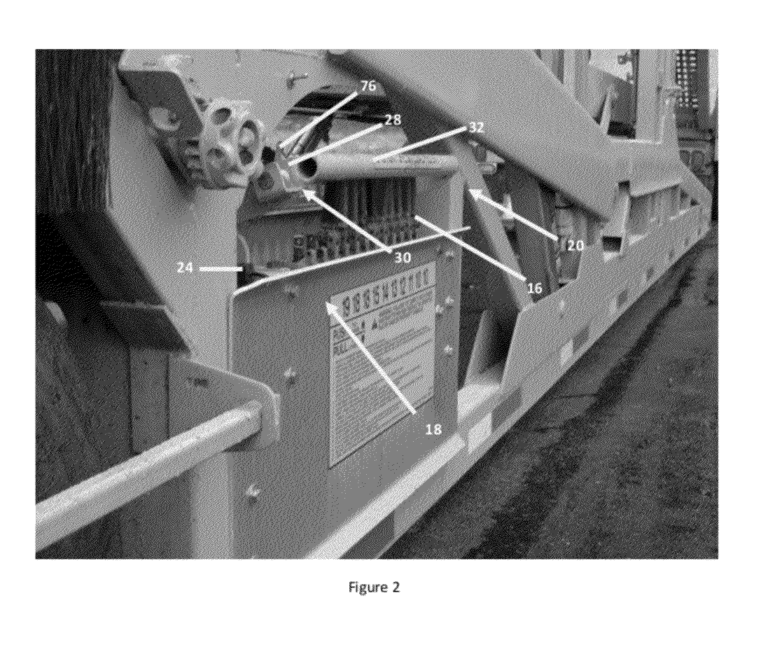

A heavy equipment system 10 is shown in FIG. 1 that includes a tractor 12 for hauling a trailer 14, wherein the trailer may have its height adjusted by a hydraulic system controlled by a bank of control levers 16. Also included is a safety system 18 that comprises a blocking member, such as a handle 20, a sensor 24 and a communication system 22, as shown in FIG. 2. The safety system 18 operates to sense and communicate to a driver of the tractor 12 the possibility that the trailer 14 is in the raised position. Advantageously, such a system can guard against a driver driving into a low overpass or other hazard with the trailer in an elevated position.

Different types of equipment than the illustrated tractor 12 and trailer 14 may be aided by the safety system. The safety system, for example, may be used on machines or other equipment that have controllers for moving or adjusting configurations or positions of various components, especially if movement of those components may pose a safety hazard for an operator. Examples include controls for automated presses or forklifts or elevator systems. The safety system is especially useful for warning machine operators remotely from the controller, such as when the operator is at another set of controls.

Referring again to the control levers 16, the levers are arranged in a bank along a side of the tractor 12 or trailer 14 to allow the driver to see movement of the trailer by the hydraulic system while operating the levers. The levers 16 rotate on a common axis and each corresponds to a valve of the hydraulic system. Pushing the levers 16 forward opens the valves and raises the trailer 14 while pulling the levers 16 closes the valves and lowers the trailer. In one example, the levers each operate a ramp of a car hauling trailer so that cars can be moved on and off the truck.

Other types of controllers may also monitored by the communication and safety system. For example, buttons or wheels or pedals or switches or dials or other types of controllers may be used alone or in combination to operate moving components of a machine and benefit from an extra layer of safety precaution. Also, as described above, a machine or system may have multiple controls located remotely (e.g., not easily visible) from each other and impacting each other's operation, such as the cab of the tractor 12 having driving controls remote from the bank of the control levers 16.

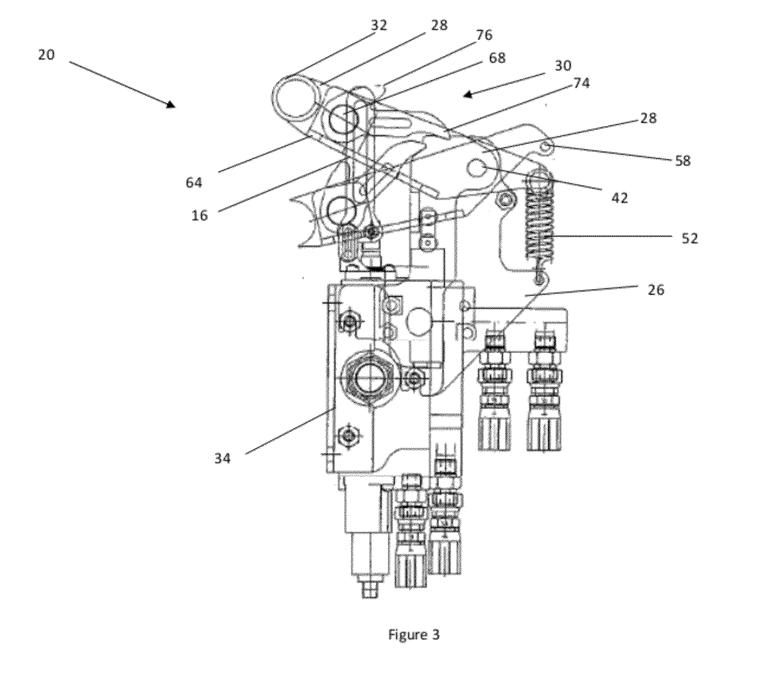

Referring now to FIG. 3, the handle 20 includes an assembly comprising first and second support plates 26 and 27, first and second pivot arms 28 and 29, a ratchet assembly 30 and a bar 32. The support plates 26 and 27, as shown in FIG. 2, are configured to mount on opposite sides of a frame 34 that supports the bank of control levers 16 on the trailer 14.

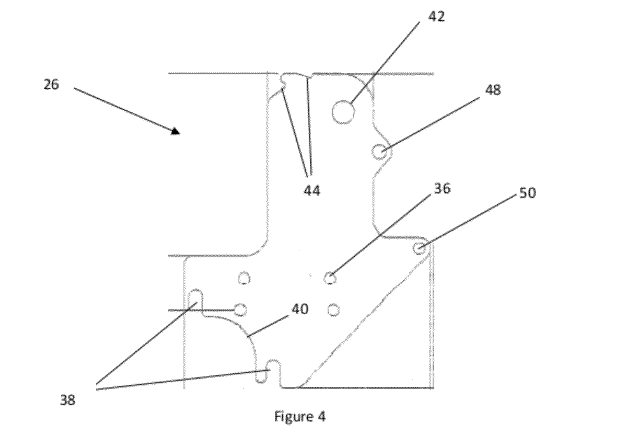

The first support plate 26, as shown in FIG. 4, includes four attachment holes 36 with a trapezoidal arrangement configured to receive fasteners for attachment to the frame 34. Also facilitating attachment and providing clearance for existing fasteners are two notches 38 defined on lower peripheral edges of the plate 26. An additional arc portion 38 of the lower edge provides clearance for a larger fastener head of the controller system.

Similarly, as shown in FIG. 5, the second support plate 27 defines securing or clearance openings 54. Two of the openings are fashioned to fit smaller fastener heads and a third larger opening for a larger fastener head. The second support plate 27 also includes one of the notches 38. When assembled to the frame, the first and second plates 26, 27 are in a parallel, spaced relationship on either side of the frame with the control levers 16 extending between them.

A flange portion of the first support plate 26 (and similar but not identical portion of the second support plate 27) extends upwards from a lower attachment portion of the support plate and supports movement functionality of the handle 20. A pivot opening 42 is defined near a top of both of the support plates 26, 27. These pivot openings 42 are configured to receive and support pins or fasteners connecting the pivot arms 28. Optionally, the pivot openings 42 of the plates are collinear and define an axis of rotation of the pivot arms.

Defined along the peripheral edge of the flange portion of the support plates 26, 27, opposite an edge adjacent the pivot opening 42, are a pair of ratchet notches 44 that, as will be described in more detail below, are configured to receive a ratchet pawl 46 when the handle 20 is in the blocking or access configurations.

On the first support plate 26, a stop opening 48 is defined below and laterally spaced from the pivot opening 42. The stop opening 48 is configured to receive a stop post or other member that blocks rotation of the pivot arms 28 and bar 32 out of a desired range. Below and even further laterally spaced than the pivot opening 42 is a sub-flange portion defining a spring mount opening 50 configured to receive a spring 52 also connected to the pivot arms 28, as shown in FIG. 3.

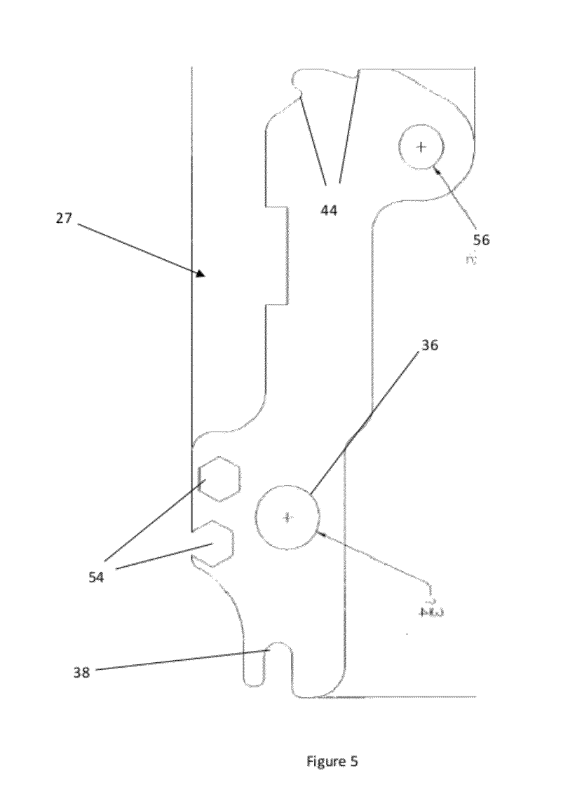

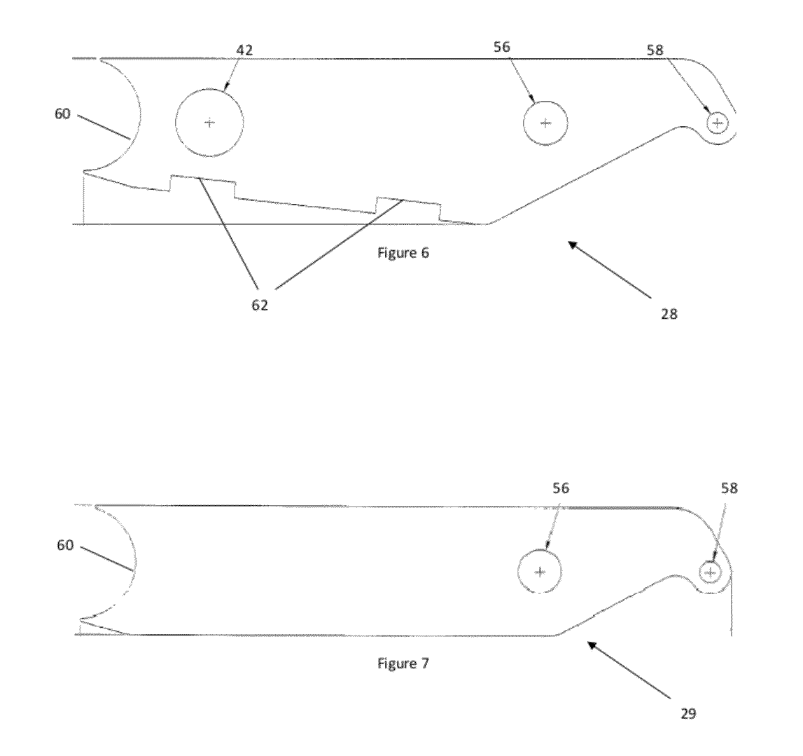

As shown in FIGS. 6 and 7, the first and second pivot arms 28, 29 are elongate plates each defining a pivot opening 56, a spring opening 58 and a bar scallop 60. The pivot opening 56 is configured to overlap and allow pivotal mounting (such as via a pin) to the pivot opening 42 of an adjacent one of the support plates 26, 27.

On one side of the pivot opening 42 is the spring opening 58 to which the spring 52 is attached with its opposite end in the spring mount opening 50 defined in the support plate, as shown in FIG. 3. A spring may be used on only one or both of the spring openings 58, although only the first one of the support plates 26 has the spring mount opening 50 in the figures. Thus, the spring(s) 52 biases the pivot arms 28, 29 to rotate with respect to the support plates.

At the opposite end of the pivot arm is defined the bar scallop 60 which is shaped and sized to receive an end of the bar 32. The bar 32 may be welded or fastened to the end of the pivot arms 28, 29 for a permanent attachment. This connects the two pivot arms so that they move in unison to support pivoting motion of the bar 32.

The first pivot arm 28 additionally defines a pair of spaced, rectangular notches 62 on its lower peripheral edge. The notches are sized and shaped to receive and connect a ratchet support angle 64 of the ratchet assembly 30. Also defined is a ratchet pivot opening 66 which is configured to receive a pivot pin 68 of the ratchet assembly 30.

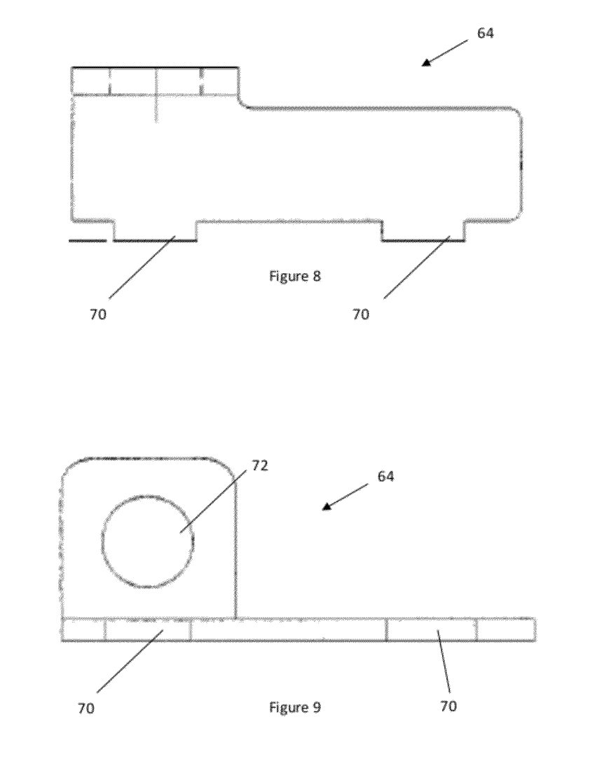

FIGS. 8, 9 and 10 show subassembly components of the ratchet assembly 30 including the ratchet pawl 46, ratchet support angle 64 and pivot pin 68. The ratchet support angle 64 includes an angled plate structure with a base portion defining a pair of spaced flanges 70 configured to fit into, and be fastened to, the rectangular notches 62 of the first pivot arm 28. At a right angle to the base portion is a tab portion that defines a second ratchet pivot opening 72 configured to receive the pivot pin 68.

In particular, when the ratchet support angle 64 is attached to the first pivot arm 28, the tab portion extends parallel to the pivot arm and the first and second ratchet pivot openings 56, 72 are aligned along a common axis. In this manner, the pivot pin 68 can be received and rotatably supported within the ratchet pivot openings to allow the ratchet pawl 46 to rotate thereabout into and out of the ratchet notches 44 of the first support plate 26. Additionally, the ratchet assembly 30 may include a coil spring that extends around the pivot pin 68 to bias rotation of the ratchet pawl 46.

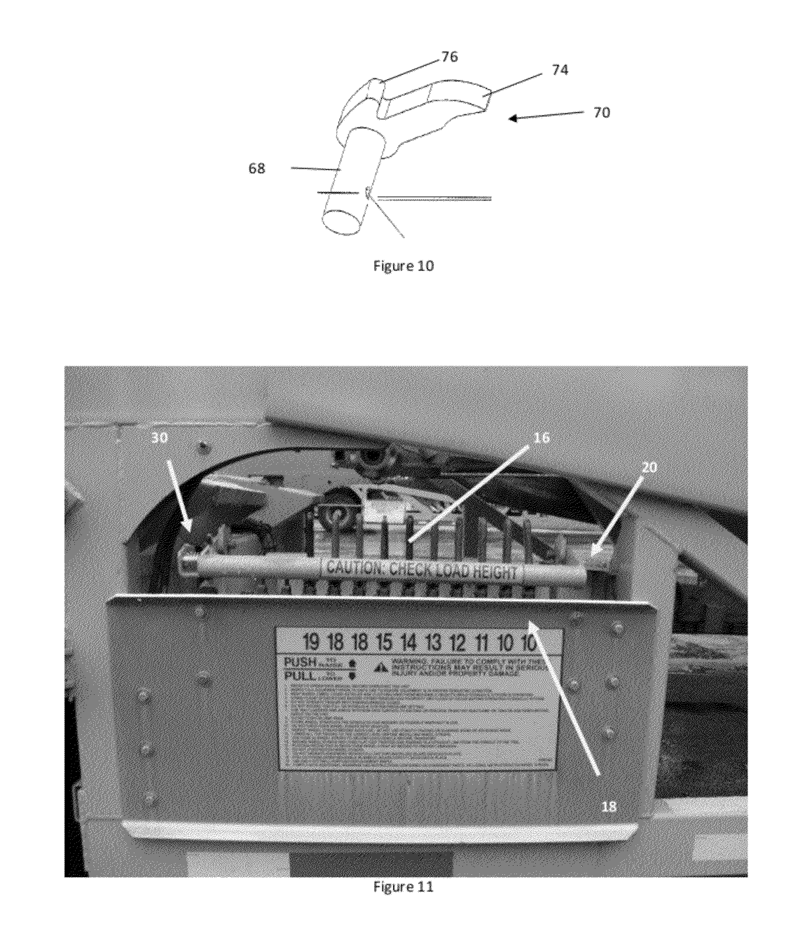

As shown in FIG. 10, the ratchet pawl 46 includes a tooth end 74 and a pull flange 76. The tooth end 74 is configured with its arc shape and tapered free end to engage the ratchet notches 44 to hold the rotation of the bar 32 with respect to the frame 34 at two indexed locations, one blocking operation of the control levers 16 and the other providing clearance for free access or operation. The pull flange 76 enables rotation of the ratchet pawl 46 against its bias to allow rotation of the bar 32.

Referring to FIGS. 2, 3 and 11, the handle assembly 20's operation can be seen between a blocking and access position. In the blocking position, as seen in FIG. 2, the pivot arms 28, 29 are rotated to their top position and bar 32 is positioned closest to the levers 16. Holding the bar 32 in this position is the bias of spring 52 on the pivot arm 28 and the engagement of tooth end 74 in topmost one of the ratchet notches 44. Also the stop mounted in stop opening 48 (as shown in FIG. 3) blocks any further advancement of the edge of the first pivot arm 28. Access to the levers 16 is not only inhibited, but the levers cannot be pulled back to lower the trailer, guarding against injury to the operator.

Movement from the blocking position to the access position (as shown in FIG. 11) is accomplished by pulling back on pull flange 76 (against its bias) so tooth end 74 disengages the topmost ratchet notch. Bar 32 is pulled downward against the bias of the spring 52 until the tooth end 74 engages the lower one of the ratchet notches 44. At this point, the bar 32 is much further away from the levers 16, allowing those levers to drop the trailer by being pulled toward the operator.

Referring again to FIGS. 1 and 2, the communication system 22 includes the sensor 24, communication lines 78 and a display 80. The sensor 24 of the communication system is mounted to the trailer 14 subjacent the some movable component of the handle 220, such as the bar 32, to facilitate sensing of handle's configuration. For example, the sensor 24 may be a switch or magnetic or optical or electronic sensor that senses the proximity of the bar 32 or the first pivot arm 28.

As shown schematically in FIG. 1, extending from the sensor 24 are communication lines 78 that connect to the display 80 in the cab of the tractor 12. Advantageously, the sensor 24 of the present system can be retrofit to an existing system that senses other attributes of the trailer 14, such as the MERITOR WABCO (Troy, Mich.) programmable logic controller (PLC) display system part no. 400 850 614 0. Intervening components include processing and memory capacity, such as an electronic control unit (ECU) on the sensor side that generates the signal when the switch or sensor is tripped. The signal is sent through the communication lines 78 (e.g., wires and wiring harness) to the PLC display mounted in the cab of the tractor 12.

In one example, when the sensor 24 senses the handle 20 is in the access position (allowing the trailer components to be raised using the control levers 16), the ECU is programmed to send a signal to the PLC controller and the display 80 shows a message such as “Critical Alarm/Load Height Too High” so the driver knows that the trailer is (or likely is) still in the elevated position. Also, other warning aspects can be employed such as flashing lights, sounds and/or a symbol such as a sketch of the tractor/trailer in red flashing on the display. Thus, before driving off, the driver knows that the trailer 14 is in the elevated position and might run into a low overpass.

Alternatively, the sensor 24 may be configured to sense when the handle 20 is in the blocking position when the blocking position is configured to stop dropping of a raised trailer component. The ECU sends the signal to the PCL controller and it can show a warning message on the display 80.

It should be noted that the form of detection and communication may have a range of applications that are not tied to any particular computer hardware or software combination or form of communication. For example, the PLC controller may contain the logic allocated to the ECU and the communication lines instead may be replaced by a radio frequency or wireless network.

Although illustrated as part of a car hauler, a range of other safety systems protective of inadvertent actuation or operation of controllers may be employed with, and benefit from the safety system.

For example, the safety system may be used when some type of controller operation is inhibited by a first safety system and operation of that safety system can be monitored by another safety system, particularly when the second safety system is at another location. For example, an assembly line that receives assemblies from an upstream assembly line may have controls in a lockable panel that activate downstream assembly. The safety system may sense that panel being locked and communicate to the upstream assembly line controller operator a warning not to initiate downstream movement of the assemblies because the locked panel is an indication that downstream assembly has not commenced. One advantage of monitoring the safety system instead of the machine itself is that machines with a wide range of configurations or movements may not lend themselves to direct placement of sensors.

Another example includes sensing the position of a cover or shield of metal or aluminum that can block access to the levers or controls. Sensing that the cover is open would result in a warning that the trailer is up.

Aspects of the safety system, such as the programming instructions on the ECU or PLC of the communication system described above, may be embodied as a system, method or computer program product. Accordingly, aspects of the safety system may take the form of a hardware system, a software system (including firmware, resident software, micro-code, etc.) or a system combining software and hardware aspects that may all generally be referred to herein as a “circuit,” “module” or “system.” Furthermore, aspects of the safety system may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present safety system may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Systems and machines are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A number of aspects of the systems, devices and methods have been described. Nevertheless, it will be understood that various modifications may be made without departing from the spirit and scope of the disclosure. Accordingly, other aspects are within the scope of the following claims.

What is claimed is:

1. A safety system for a machine having a controller configured to move a component of the machine, the safety system comprising:
a blocking member configured to inhibit operation of the controller;
a sensor configured to sense a position of the blocking member; and
a communication system connected in communication with the sensor and configured to communicate information about a position of the machine component based on the sensed position of the blocking member.

2. A safety system of claim 1, wherein the blocking member is configured to move into a blocking position inhibiting operation of the controller and an access position enabling operation of the controller.

3. A safety system of claim 2, wherein the sensor is configured to sense when the blocking member is in one of the blocking or access positions.

4. A safety system of claim 3, wherein the controller is configured to raise and lower the machine component.

5. A safety system of claim 4, wherein the blocking position of the blocking member inhibits operation of the controller for lowering the machine component.

6. A safety system of claim 5, wherein the controller includes at least one lever.

7. A safety system of claim 6, wherein pushing the lever forward raises the component of the machine and pulling the lever back lowers the component of the machine.

8. A safety system of claim 7, wherein the blocking member includes a handle configured for movement from the blocking position to the access position.

9. A safety system of claim 8, wherein the handle is an elongate bar that, in the blocking position, extends into a path of travel of the lever.

10. A safety system of claim 9, wherein the elongate bar, in the blocking position, blocks pulling of the lever.

11. A safety system of claim 9, wherein the elongate bar, in the blocking position, extends perpendicular to the path of travel of the lever.

12. A safety system of claim 11, wherein the elongate bar, in the blocking position, extends perpendicular to a path of travel of a plurality of the levers.

13. A safety system of claim 1, wherein the blocking member includes a handle configured for movement from the blocking position to the access position.

14. A safety system of claim 13, wherein the blocking member includes a pivot about which the handle pivots from the blocking position to the access position.

15. A safety system of claim 14, wherein the handle extends from the pivot point.

16. A safety system of claim 15, wherein the handle includes an elongate bar that, in the blocking position, extends perpendicular to a path of travel of the controller.

17. A safety system of claim 16, wherein the controller and the handle pivot about parallel axes.

18. A safety system of claim 17, wherein the elongate bar pivots about an arc at a greater radius than an arc about which the controller pivots.

19. A safety system of claim 1, wherein the communication system includes a display configured to show a warning.

20. A safety system of claim 19, wherein the display is remote from the controller and not visible while operating a second controller.

21. A safety system of claim 19, wherein the second controller is configured to move a second component of the machine.

22. A safety system of claim 20, wherein the warning is associated with movement of the component of the machine.

23. A safety system of claim 21, wherein the machine is a trailer and wherein the movement includes raising and lowering of the trailer.

24. A safety system of claim 22, wherein the warning includes indicia of the trailer being in a raised position.

25. A safety system of claim 23, wherein the display is mounted in a cab of a tractor connected to the trailer.

26. A method of communicating a position of a component of a machine operated by a controller, the method comprising:
receiving a signal from a sensor, the signal associated with the position of a blocker configured to inhibit or enable operation of the controller; and
communicating information about the position of the machine component based on the signal from the sensor.

27. A method of claim 25, wherein the signal indicates the blocking member is in an access position enabling operation of the controller.

28. A method of claim 26, wherein communicating includes communicating that the machine component may be raised.

29. A method of claim 27, wherein communicating includes displaying indicia indicating that the machine component may be raised.

30. A method of claim 28, wherein communicating includes displaying indicia indicating that a trailer may be raised.

31. A method of claim 29, wherein the signal indicates the blocking member is in a blocking position inhibiting operation of the controller.

32. A method of claim 30, further comprising communicating that the machine component is lowered.
